(19) United States
(12) Patent Application Publication
(10) Pub. No.: US 2010/0095720 A1
(43) Pub. Date: Apr. 22, 2010

(54) LOCKING DEVICES

(75) Inventor: Leon Troy Howarth, Brisbane (AU)

Correspondence Address: FITZPATRICK CELLA HARPER & SCINTO, 1290 Avenue of the Americas, NEW YORK, NY, 10104-3800, US

(73) Assignee: VIEWQUEST PTY LTD, Brisbane (AU)

(21) Appl. No.: 12/530,701

(22) PCT Filed: Mar. 17, 2008
(86) PCT No.: PCT/AU2008/000382

§ 371 Date: Sep. 10, 2009

(30) Foreign Application Priority Data
Mar. 15, 2007 (AU) 2007901350

(51) Int. Cl. G05G 5/00; F16H 21/16

(52) U.S. Cl. 70/174; 74/25

(57) ABSTRACT

A tool carrier assembly (100) comprising a main body (101), a quick hitch (102), and a rotatable locking device (103) between the quick hitch and the main body. The rotatable locking device employs releasable locking means (104,105) at opposite ends. A scroll plate (106), cylinder (107) and piston (108) which upon assembly is located inside the cylinder) are located between the releasable locking means (104,105). In normal operation the piston (108) is driven back and forth to tilt the hitch by reason of rotation of the cylinder as guide (109) travels in the helical guide way (110) of the scroll plate (106). The hitch is fixed to the cylinder and the main body is fixed to the scroll plate. The releaseable locking means (104) and (105) each comprise an internally tapered end cup (111), bearing (112), an unlock piston (113), a locking element (114) and a locking spring (115). The springs (115) bias the locking elements into the internal taper of the end cups (111) against the piston (113), the cylinder in this embodiment has an outward taper so the locking element wedges in as shown. In order to change the relative position of the tool and the main body the assembly must be unlocked, the pistons (113) are displaced toward each other releasing the locking elements and freeing the cylinder, the cylinder and piston are a double acting cylinder assembly so as fluid flows into and out of each side as desired the cylinder will rotate, upon reaching the required angle the unlocking fluid is relieved and the springs lock the assembly.

### TECHNICAL FIELD OF THE INVENTION

THIS INVENTION relates to locking devices suitable for tiltable tool carriers and in particular but not limited to improvements in or in relation to tiltable tool carriers of the type employing an automatically locking helical guided linear to rotary convertor. More particularly the present specification relates to a tiltable tool of an earth moving vehicle.

### BACKGROUND TO THE INVENTION

Applicant's Australian patent 2001283711 also published as WO 02/18714 (HOWARTH) describes a locking device for tilting a tool. This locking device overcomes the prior art problem of the tool being held in its selected position by maintenance of hydraulic pressure on a piston, thus loading the piston as the tool is being used. HOWARTH teaches an arrangement where the hydraulics used to rotate the tool is not used to hold the device in operative position but rather a releasable locking means is employed to mechanically lock the tool at a selected position independent of the hydraulics used to move it into position. Specifically, the normal operating position is in a “locked” position by a locking spring at one end closing tapered locking elements at opposite ends. Hydraulic fluid under pressure is used enabling weaker unlocking springs to “unlock” the tapered locking elements of the locking device. During normal “locked” operation there is no need for hydraulic pressure to be maintained to the locking device once it is in a desired position since it is mechanically locked solely by springs.

A problem arises with this arrangement in so far as it uses a scroll arrangement to tilt one body part holding the tool relative to a main body part and the unlocking action itself causes an initial shift between the body parts. Thus upon applying an unlocking force there is an initial relative displacement of the two parts resulting in an initial tilt quite apart from the controlled tilting. This does not have any effect on the selection and setting of the operating angle, which is set afterwards but it does mean that there is an undesirable tilt which may be dangerous if a load is attached or suspended from the tool since the load will also tilt.

Accordingly it is an object of one aspect of the present invention to solve this problem of the prior art by preventing the initial tilt upon unlocking.

Another problem arises with the delivery of hydraulic fluid to ancillary hydraulically driven apparatus or accessories used near the tool, in terms of relay of the driving fluid to ancillary hydraulically driven apparatus or accessory in so far as hoses are prone to damage.

Accordingly it is an object of another separate aspect of the present invention to solve this problem of the prior art by providing a concealed relay of hydraulic fluid.

### OUTLINE OF THE INVENTION

In one aspect therefore the present invention resides in a locking device for a rotatable body coupled to a main body, the locking device having releasable locking means to lock the rotatable body against rotation relative to the main body, the releasable locking means being automatically biassed to a normally locked position and there being release means employed to first release the locking means thereby enabling the rotatable body to be rotated as may be required, the improvement comprising release means adapted to release the locking means while the main body and the rotatable body remain stationary.

In another aspect there is provided a tiltable tool carrier having a main body, a rotatable body coupled to the main body and being able to rotate relative to the main body and a relay for hydraulic fluid having an inlet and an outlet connected by an internal flexible hose, the hose being configured for angular displacement of the input relative to the output upon tilting of the tool carrier. The internal hose is preferable a retractable hose and it is typically coiled so that it may uncoil and recoil.

In one preferred embodiment there is provided a locking device for a tiltable tool carrier having a main body, a rotatable body coupled to the main body and a relay for hydraulic fluid, the rotatable body being able to rotate relative to the main body, releasable locking means to lock the rotatable body against rotation relative to the main body, the releasable locking means being automatically biassed to a normally locked position and there being release means employed to first release the locking means thereby enabling the rotatable body to be rotated as may be required, the release means adapted to release the locking means while the main body and the rotatable body remain stationary, the relay for hydraulic fluid having an inlet and an outlet connected by an internal flexible hose, the hose being configured for angular displacement of the input relative to the output upon tilting of the tool carrier.

Preferably, the hose of the relay is coiled.

Preferably, the locking device includes a Unearth rotary convertor where first and second drive means drive respective axially moveable pistons to shift the rotatable body to follow a helical guide and thereby tilt.

Preferably, the release means comprises respective unlocking pistons at opposite ends of the linear to rotary convertor which pistons serve to separate the locking means at each end of the convertor while the convertor remains stationary in the same position where it was locked. Preferably, the release means each comprise a internally tapered end cup, bearing, an unlock piston, a locking element and a locking spring.

Preferably, there is control means which in one embodiment comprises a hydraulic control means and the unlocking pistons and main piston drive means are pressurised through a common hydraulic drive operable in sequence to firstly unlock the locking means at a first hydraulic pressure and then apply a differential pressure to rotate the rotatable body.

Where the control means is hydraulic the hydraulic pressure is preferably employed to unlock the device but the device is not under the influence of hydraulic pressure when it reverts to the locked position.

In one preferred aspect the invention resides in a tiltable tool assembly in combination with a machine having an articulated arm with the tool assembly mounted at the end of the arm, the tool being mounted on the arm by a hitch assembly, the tool assembly being tiltable and lockable in a selected position by a locking device having opposite ends and employing releasable locking means at each end, and upon unlocking the assembly remains in the selected position and there being hydraulic drive means to enable tilting of the assembly after it is unlocked.

The control means typically comprises a hydraulic circuit selectively delivering hydraulic fluid in sequence to the drive means to first unlock and then upon actuation rotate the rotatable body. In the case where a convertor is employed in a normally locked position the control means usually operates to unlock the convertor then upon actuation rotate the rotatable body and then release means is deactivated thereby automatically locking the output at a new position.

In other preferred embodiments where the assembly is under hydraulic control the hydraulic control can take many forms, for example the hydraulic control may include an hydraulic circuit delivering hydraulic pressure to the unlocking pistons to unlock the assembly and then automatically delivering hydraulic pressure to subsequently perform the rotation as an apparent seamless manual movement of a manual control. In one form the rotation follows the unlocking by way of an automatic time delay. The time delay may be achieved in any way but is preferably achieved through the hydraulics and may include for example the use of common feed with a bleed valve to delay delivery of pressure to the main piston or by using one or more valves actuated at a predetermined pressure following the unlocking to pass pressure to the main piston. It is preferred that once the desired rotation is achieved it is again preferable that the manual control returns automatically to a neutral position, being typically a central position of a joystick, the neutral position meaning a position where pressure is bled from the unlocking pistons and the assembly is automatically mechanically locked. Pressure may also then be released from the main piston.

In order that the present invention may be more readily understood and be put into practical effect, reference will now be made to application of the present invention to a hitch for a tiltable bucket on an excavator, but it will be appreciated the example applies generally to tools including rippers, hammers, rollers, blades and mowers. Moreover, the invention can be used anywhere where controllable rotation and in particular self locking controllable rotation is desired.

### BRIEF DESCRIPTION OF THE INVENTION

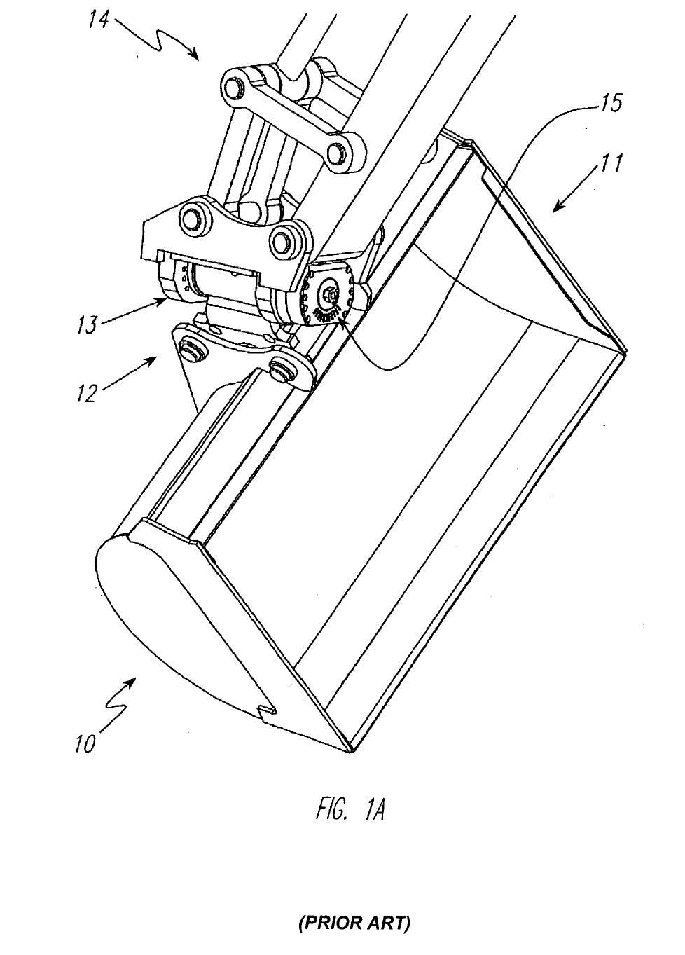

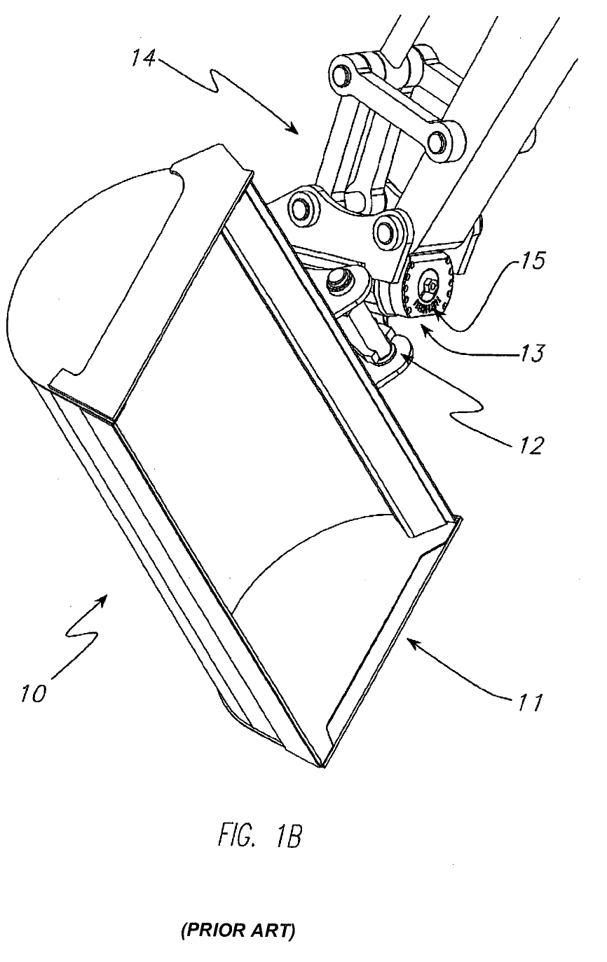

FIGS. 1A and 1B are perspective views illustrating a tiltable bucket at ninety degree extremes between right and left tilted positions where a locking device according to the prior art is used;

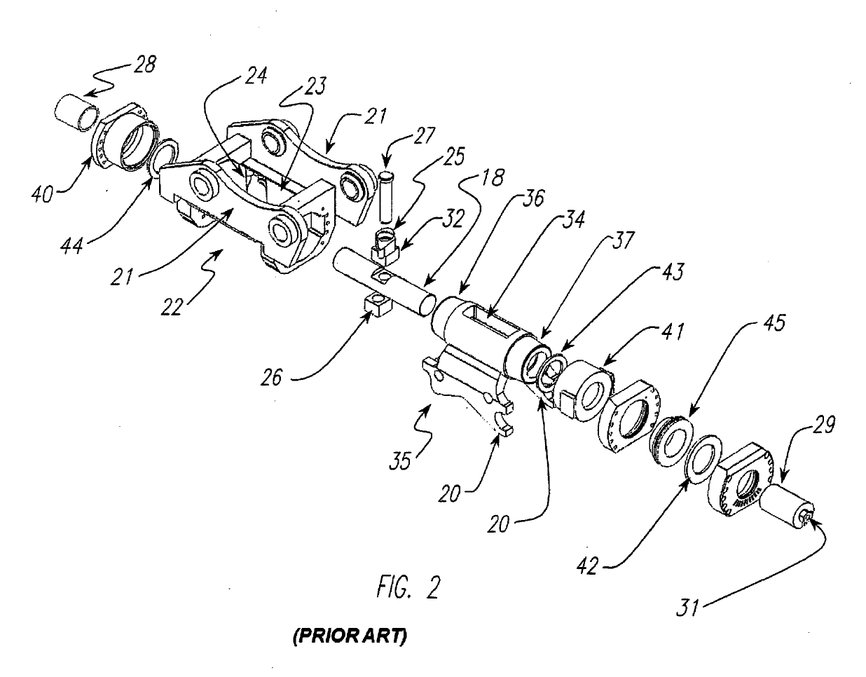

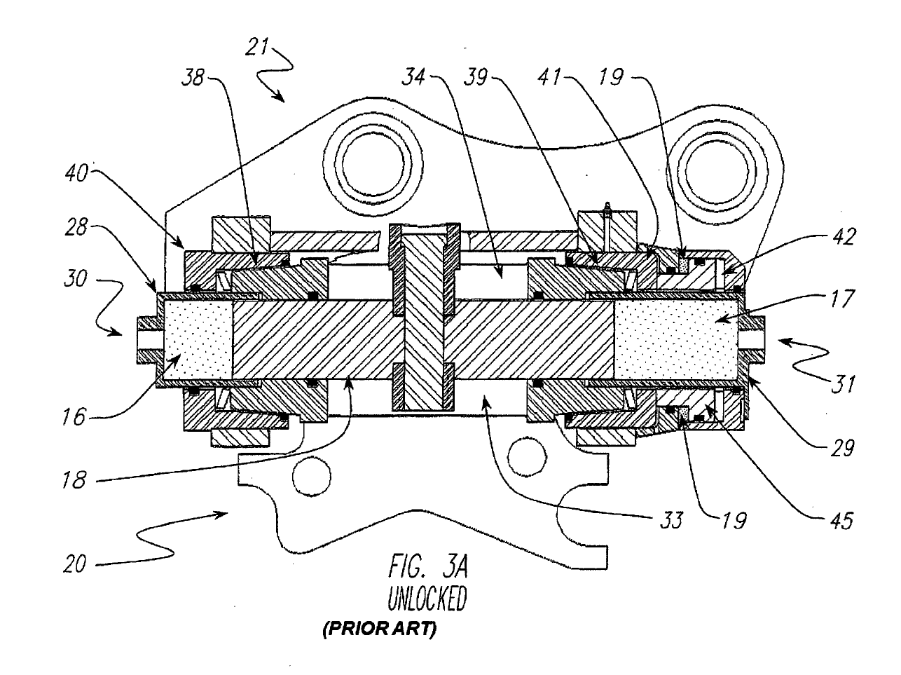

FIG. 2 is an exploded view of a hitch assembly employing a locking device according to the prior art;

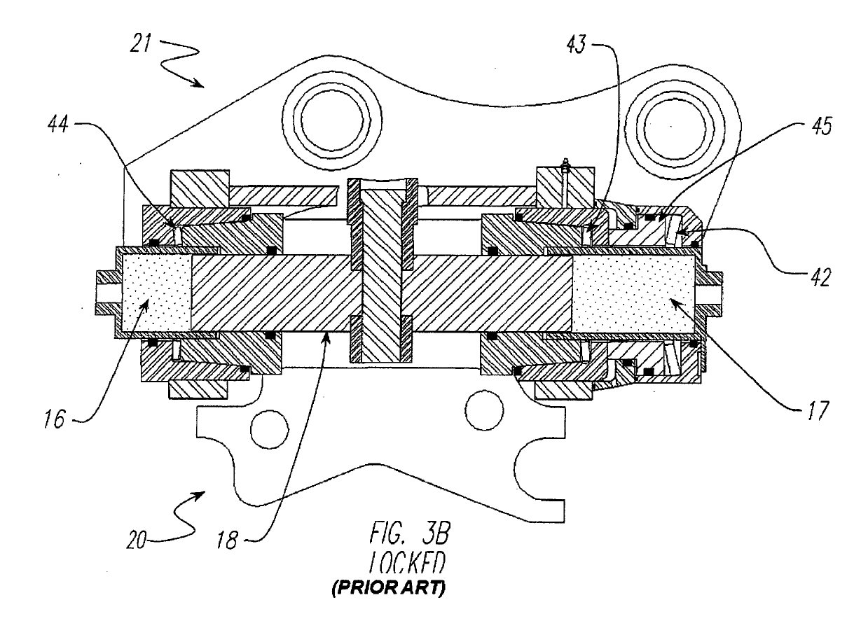

FIGS. 3A and 3B are axial sections illustrating the prior art locking device in unlocked and locked positions respectively;

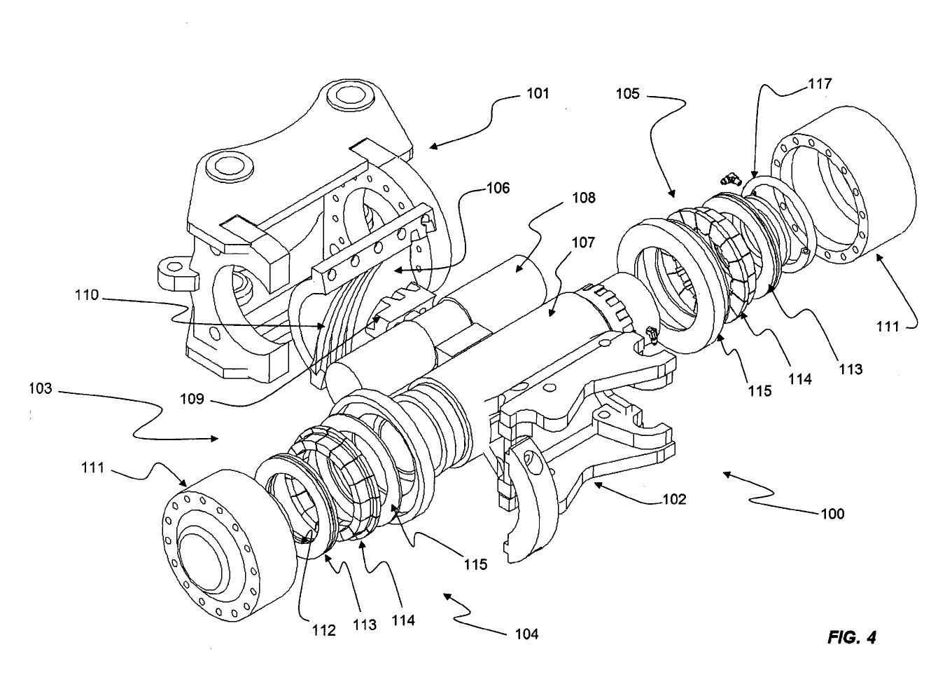

FIG. 4 is an exploded view of a hitch assembly employing a locking device according to the present invention;

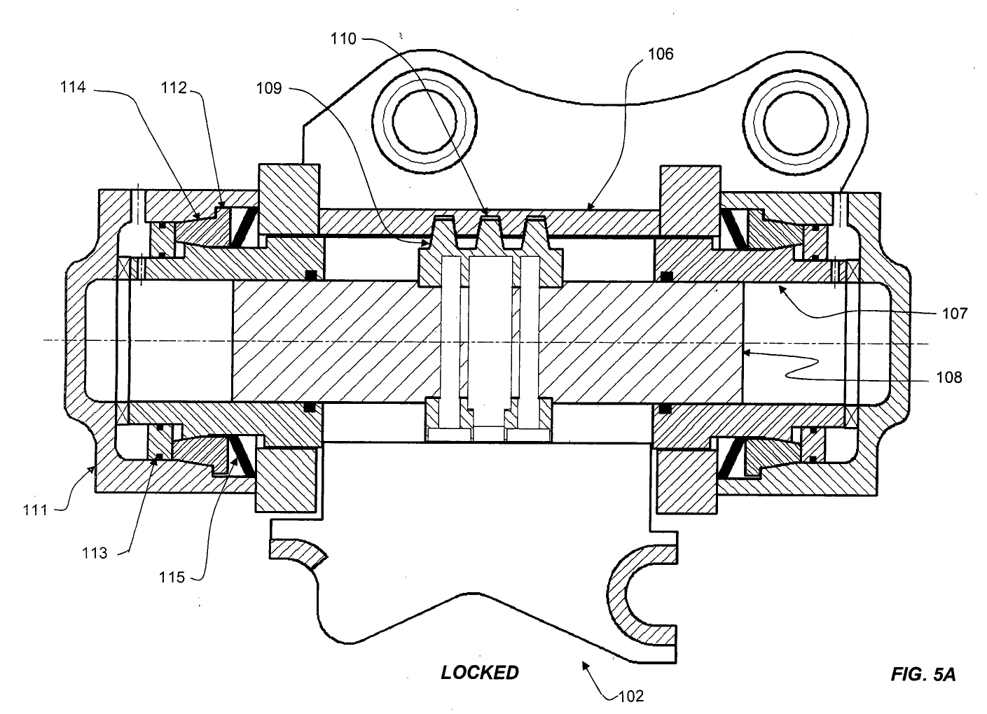

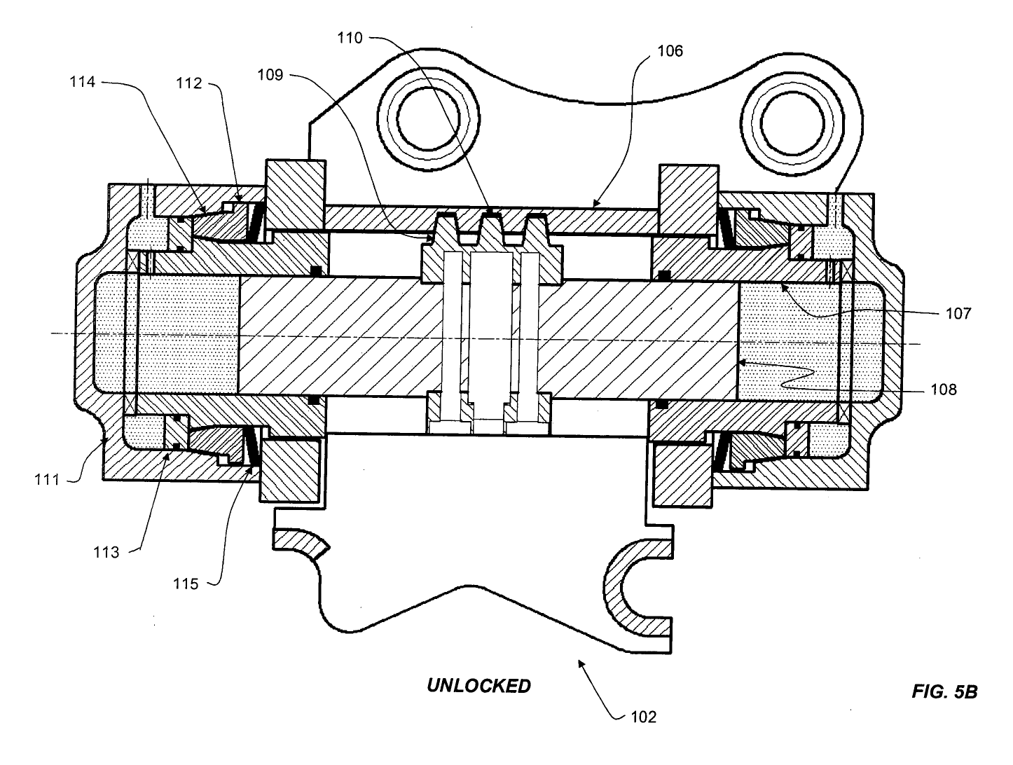

FIGS. 5A and 5B are longitudinal midline sections through a locking device according to the present invention showing the locking device in locked and unlocked states respectively;

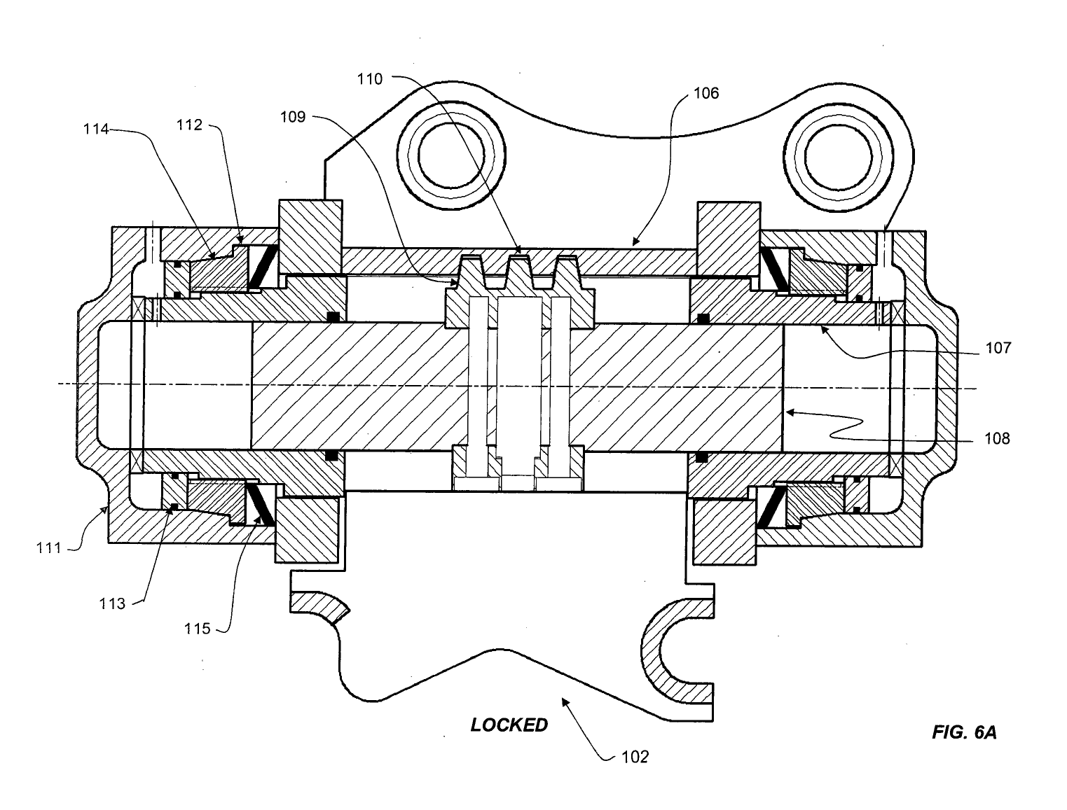

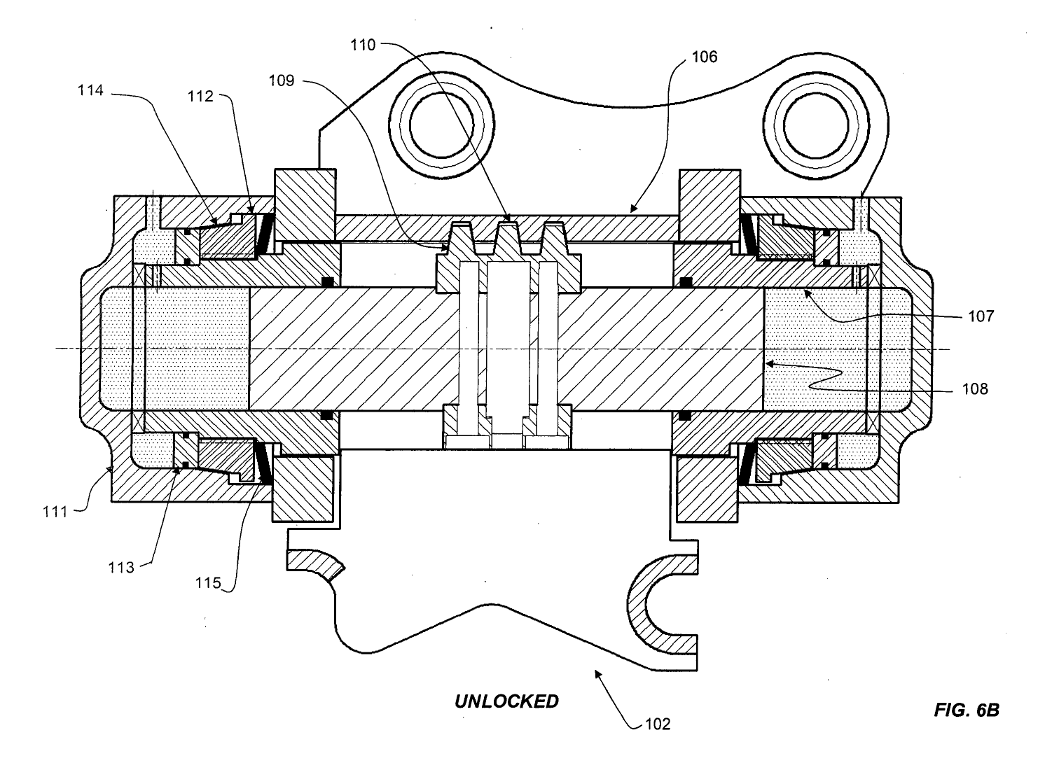

FIGS. 6A and 6B are longitudinal midline sections through another embodiment of a locking device according to the present invention showing the locking device in locked and unlocked states respectively;

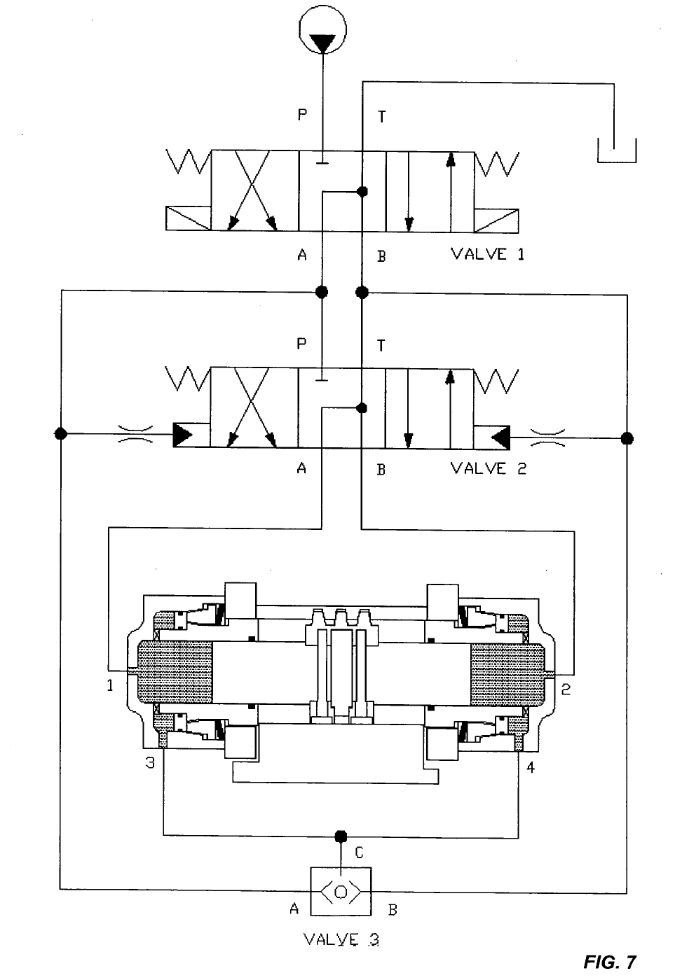

FIG. 7 is a first hydraulic circuit schematic illustrating a typical control means suitable for controlling a locking device according to the present invention;

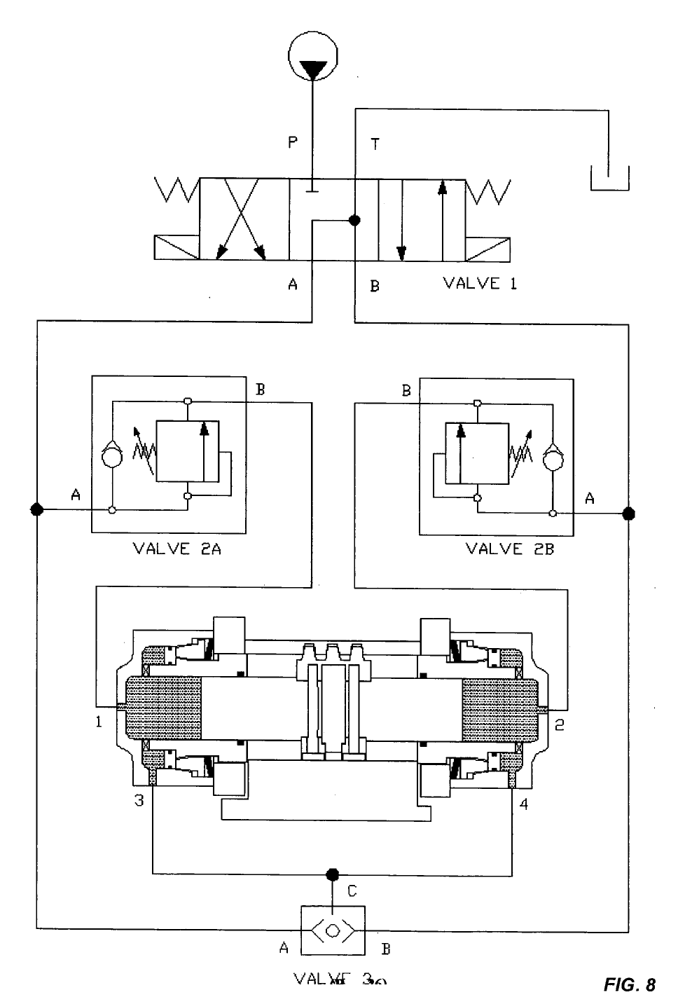

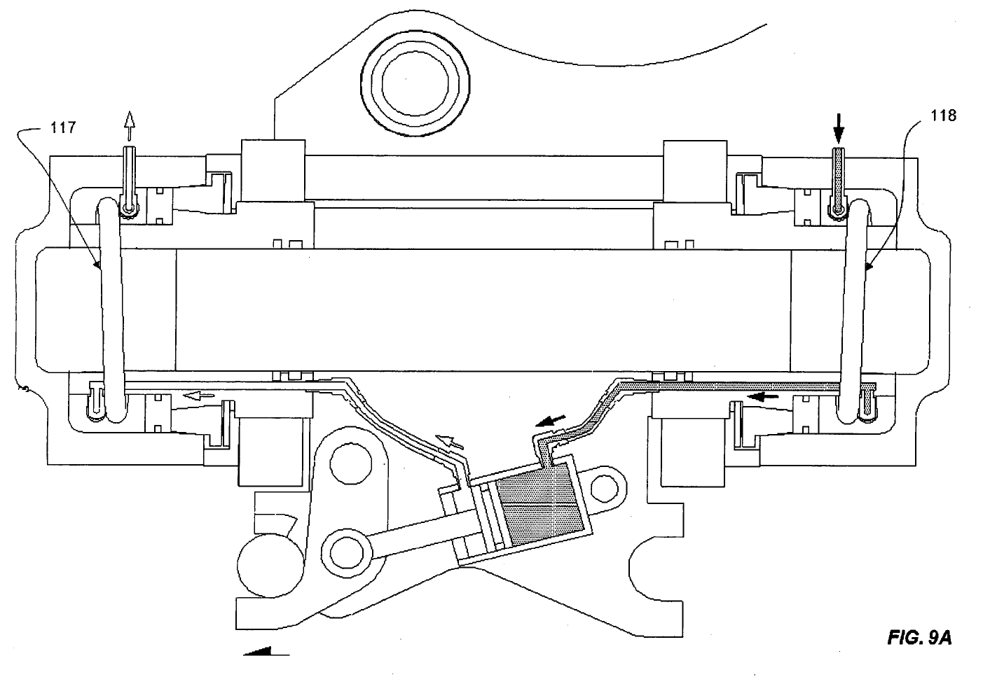

FIG. 8 is second alternative hydraulic circuit schematic illustrating a typical control means suitable for controlling a locking device according to the present invention; and

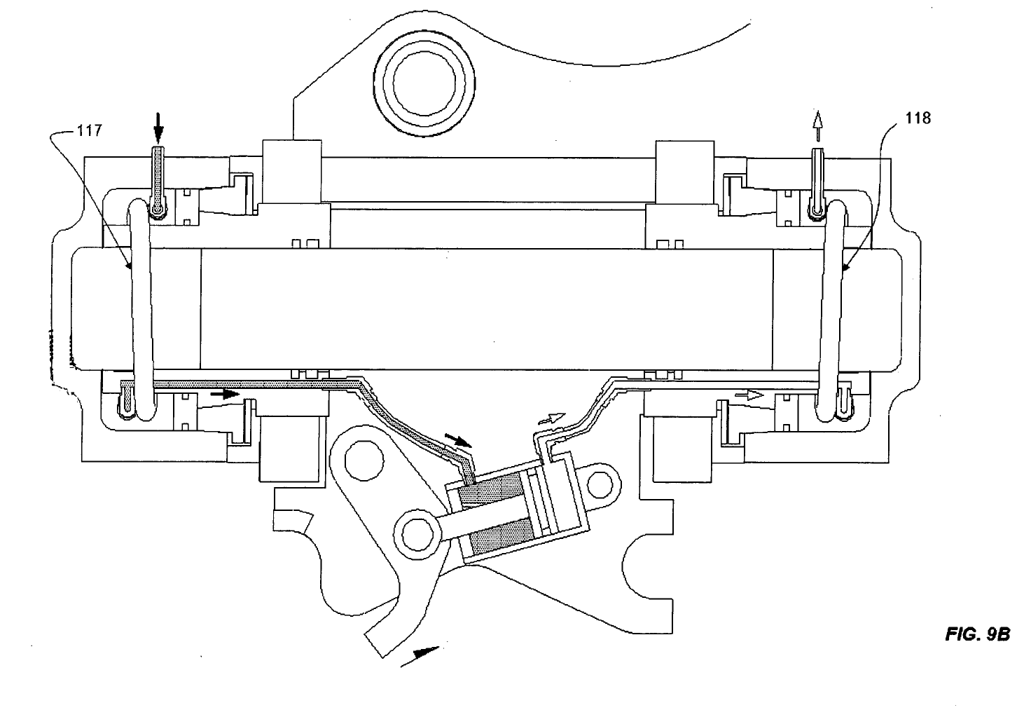

FIGS. 9A and 9B are drawings illustrating operation of the hydraulics of a “quick hitch” where the hydraulic fluid is relayed through an internal relay in accordance with the present invention.

### METHOD OF PERFORMANCE

Referring to the prior art drawings and initially to FIGS. 1A and 1B there is illustrated a bucket assembly 10 including a bucket 11 releasably held by a hitch assembly which is typically a quick release hitch assembly 12 (details being omitted for sake of clarity) and in this case employs a locking device in the form of a controlled linear to rotary convertor 13 between industry standard couplings altogether securing the bucket to, in this example, an articulated arm assembly 14 of an earthmoving vehicle (not shown). The linear to rotary convertor 13, and consequently the bucket assembly, includes a visual readout, in this case a scale and pointer at 15 which enables an operator to visually identify the angular position of the bucket from the scale. As can be seen in FIG. 1A the bucket is tilted to the right at forty-five degrees and in FIG. 1B it is tilted to the left at forty-five degrees. A joystick controller (not shown) is employed to control the bucket position preferably using hydraulic drives and control to be described below.

As will be appreciated from the following description the bucket 11 can be rotated continuously through the full ninety degree range and can be selectively locked at any angular position within that range. It will be appreciated, however, that in relation to the tilting of a bucket assembly, while a ninety degree angular range may be applicable, in this and other applications the linear to rotary convertor can be configured for other angular ranges as may be desired.

Referring now to prior art FIGS. 2, 3A and 3B construction of the linear to rotary convertor and its operation will now be described and illustrated. As can be seen most clearly in FIGS. 3A and 3B, the linear to rotary convertor employs a double acting hydraulic cylinder assembly with hydraulic fluid illustrated in dotted form at 16 and 17 on opposite sides of a main piston in the form of a scroll cylinder shaft 18. A first drive means is used to unlock the device, the hydraulic fluid for the first drive means being illustrated in the dotted section at 19 in FIG. 3A. A second drive means is the double acting cylinder assembly and a fully automatic cone locking structure is utilised at opposite ends of the assembly and this can plainly be seen in FIGS. 3A and 3B. It will be appreciated from the following description that the normal operating position of the assembly is in a “locked” position by reason of third and fourth drive means in the form of opposed biassing springs and that hydraulic fluid under pressure to the first drive means is used to overcome a stronger locking spring and to enable a weaker unlocking spring to “unlock” tapered locking elements of the locking device. This means that during normal “locked” operation there is no need for hydraulic pressure to be maintained to the locking device once it is in a desired position since it is mechanically locked solely by springs. It will also be appreciated that once the tapered locking elements are in position, hydraulic fluid to 16 and 17 is irrelevant to the continued operation of the assembly which is essentially and effectively a rigid coupling between the standard quick hitch ears 20 and pin ears 21.

The ears 21 are part of a rotary output in main body 22, the main body 22 having a scroll plate 23 which has a helical slot 24 forming a scroll guide way cooperating with a scroll guide 25. The scroll guide 25 is pinned to the scroll cylinder shaft 18 by a guide block 26 and a scroll guide fixing pin 27. As the shaft 18 is driven axially it is caused to rotate by the guide 25 travelling along the guide way 24 in a helical fashion.

The scroll cylinder shaft 18 travels at opposite ends in respective first and second scroll cylinder barrels 28 and 29 which have respective hydraulic fluid inlets 30 and 31, the guide block 26 and the square guide section 32 of the guide 25 travel axially in guide slots 33 and 34 respectively. Slots 33 and 34 are formed in a second body 35 which is formed integrally with the ears 20. It will therefore be appreciated that the second body 35 and the ears 20 rotate in concert with the scroll cylinder shaft 18 as the guide 25 moves along the guide way 24 but that the two bodies are locked together by the tapered locking elements. The body 35 has opposite cones 36 and 37 which are matched to internal cone surfaces 38 and 39 respectively of fixed tapered cup 40 and sliding tapered cup 41 respectively. Sliding tapered cup 41 is splined against rotation relative to the main body.

A locking spring disk 42 normally overcomes the unlocking spring disks 43 and 44 so that the cones 36, 37, 38 and 39 are in locking register and the assembly is in the position illustrated in FIG. 3B. On application of the first drive means hydraulic fluid is delivered into the annular space illustrated at 19 to assist the springs 43 and 44 to overcome the bias of the locking spring 42 by moving unlocking piston 45 to the right thereby enabling the unlocking springs 43 and 44 to apply separating bias to release the engagement of the cone surfaces 36, 37, 38 and 39 so that application of hydraulic fluid under pressure at 16 or 17 will cause the scroll cylinder shaft 18 to rotate and thereby rotate the ears 20 to a desired position as can be read directly off the scale 15 of FIGS. 1A and 1B. Upon release of hydraulic pressure to the first drive means, the device will automatically revert to the locked position.

Referring now to FIG. 4 and in comparison to the prior art, it will be appreciated that although some features are shared in common the present invention differs conceptually in its broad aspects as well as in specific operation of the preferred forms due to the use of separate release means driven apart at opposite ends. In the prior art a scroll is used along with the locking spring biassed tapered locking elements. However, in the prior art the locking and unlocking at each end was dependent upon a single locking spring combined with movement of the main piston as part of the unlocking process. This resulted in undesirable and potentially dangerous movement as part of the unlocking phase. In the present invention, this movement has been eliminated.

As concerns FIG. 4 there is illustrated a preferred embodiment of the invention drawn similar to FIG. 2 where a tool carrier assembly 100 comprises a main body 101, a quick hitch 102, and a rotatable locking device 103 between the quick hitch and the main body. The rotatable locking device employs releasable locking means 104,105 at opposite ends, the main body and quick hitch portion will change depending upon the application of the invention but in this case the application illustrated is as for the example in FIGS. 1A and 1B. A scroll plate 106, cylinder 107 and piston 108 (which upon assembly is located inside the cylinder) are located between the releasable locking means 104,105. In normal operation the piston 108 is driven back and forth to tilt the hitch by reason of rotation of the cylinder as guide 109 travels in the helical guide way 110 of the scroll plate 106. The hitch is fixed to the cylinder and the main body is fixed to the scroll plate thus they are able to tilt relative to one another and thereby tilt a tool hitched to the quick hitch.

The releasable locking means 104 and 105 each comprise an internally tapered end cup 111, bearing 112, an unlock piston 113, a locking element 114 and a locking spring 115. Hydraulic pressure is used to overcome the spring force for the purpose of unlocking.

The assembled configuration is shown in FIGS. 5A (UNLOCKED)and 5B (LOCKED). The springs 115 bias the locking elements 114 into the internal taper of the end cups 111 against the piston 113, the cylinder portion of the end cups 114 in this embodiment has an outward taper so the locking element wedges in as shown. In order to change the relative position of the tool and the main body the assembly must be unlocked as shown in FIG. 5B, the pistons 113 are displaced toward each other simultaneously releasing the locking elements and freeing the cylinder 106, the cylinder 106 and piston 108 are a double acting cylinder assembly so as fluid flows into an out of each side as desired the cylinder will rotate, upon reaching the required angle the unlocking fluid is relieved and the springs 115 lock the assembly returning to the FIG. 5A position.

FIGS. 6A (LOCKED) and 6B (UNLOCKED) illustrate a further embodiment where the locking elements in this case as splined to the cylinder portion of the end cups rather than having the tapered cylinder of the previous embodiment. The operation is the same as in FIGS. 5A and 5B respectively.

FIGS. 7 and 8 illustrate representative and exemplary hydraulic control. In the present example a joystick manual control is used and when it is released and returns to its central position the assembly automatically locks. Likewise as the joystick it is moved the unlocking and rotation appear seamless to the operator. This seamless operation may be achieved in many ways not only using solely hydraulics but in the examples which follow the control of the sequence of unlocking and rotation is performed using hydraulics. It will be understood that the control may vary and variation will be apparent to persons of ordinary skill in the art.

Referring to FIG. 7, this embodiment shows a hydraulic circuit in hydraulic connection with the tilting device whereby valve 1 is a three position directional control valve in which the centre position vents both ports A and B to tank. Valve 2 is a pilot actuated three position directional control valve in which the centre position vents both ports A and B to tank. Valve 3 is a shuttle valve which permits the higher pressure to flow from either port A or B to port C and free flow in the reverse direction.

Selectively positioning either of the end two positions of valve 1 allows hydraulic oil to flow via either port A or B of valve 1. Oil then flows into either port A or B of valve 3 which shuttles to permit oil to flow out via port C to the unlock pistons 113 which are then biased to the unlock position. Oil flows simultaneously into the pilot ports of valve 2 via suitable flow restriction causing a time delay before permitting valve 2 to move to either of its two end positions, which allows oil to flow to either port A or B of valve 2 permitting oil to then flow into ports 1 or 2 of the tilt device whereby oil then biases the respective end of piston 108 to tilt the cylinder 107 in the respective direction. The opposite end of piston 108 is open to flow oil to tank. A suitable flow restriction or throttle device (not shown) may also be utilised to control flow of oil from piston 108 to tank in order to maintain a steady tilt motion.

Once tilted the desired amount the operator selects the centre position of valve 1 which drains oil flow from ports A and B of valve 1 to tank. This immediately relieves pressure from port C of valve 3 which returns unlock pistons 113 to the locked position via unlock springs 115 normally locked bias. Oil flow from valve pilot of valve 2 via the flow restrictors permits valve 2 to spring return to centre position to expose both sides of tilt piston 108 oil flow to tank therefore removing oil flow and pressure from the tilt device and locking it against tilting.

Referring to FIG. 8, in this embodiment there is illustrated a hydraulic circuit in connection with the tilting device in which valve 1 is a three position directional control valve whereby the centre position vents both ports A and B to tank. Valve 2A and 2B are hydraulic sequence valves which permit flow from port A to B at an adjustable pressure and free flow in the reverse direction. Valve 3 is a shuttle valve which permits the higher pressure to flow from either port A or B to port C and free flow in the reverse direction.

Selectively positioning either of the end two positions of valve 1 allows hydraulic oil to flow via either port A or B of valve 1. Oil then flows respectively into port A or B of valve 3 which shuttles to permit oil to flow out via port C to the unlock pistons 113 which are then biased to the unlock position. Oil flows simultaneously into ports A of valve 2A or 2B respectively and upon reaching the pressure setpoint of valves 2A or 2B permit oil to flow into ports 1 or 2 of the tilt device whereby oil then biases the respective end of piston 108 to tilt the cylinder 107 in the respective direction. The opposite end of piston 108 is open to flow oil to tank. A suitable flow restriction or throttle device (not shown) may also be utilised to control flow of oil from piston 108 to tank in order to maintain a steady tilt motion.

Once tilted the desired amount the operator selects the centre position of valve 1 which drains oil flow from ports A and B of valve 1 to tank. This immediately relieves pressure from port C of valve 3 which returns unlock pistons 113 to the locked position via unlock springs 115 normally locked bias. Oil flows simultaneously from valves 2A and 2B to tank therefore removing oil flow and pressure from the tilt device and locking it against tilting.

Additionally in another embodiment, ports 1 and 3 of the tilt device could be directly connected at one end of the tilt device and ports 2 and 4 could be directly connected at the corresponding opposite end of the tilt device in a way such to permit the unlock and tilt functions at each respective end to share oil pressure and flow as a drive means.

In this way pressurising ports 1 and 3 simultaneously with ports 2 and 4 would firstly permit the device to unlock while simultaneously holding the tilt piston 108 from moving. Secondly, then reducing the pressure at either ports 1 and 3 or ports 2 and 4 would cause the piston 108 to move toward the lower of the pressures due to a pressure differential and result in tilting the cylinder 107. Additionally any loss of hydraulic pressure at either end of tilt piston 108 or unlock piston 113 to a level below that of the locking spring 115 bias would cause automatic locking of the tilt device and therefore “failsafe” lock operation in the event of partial or complete hydraulic pressure loss.

A suitable hydraulic circuit similar to those shown in FIG. 7 or 8 could be utilised with suitable valving to provide and maintain a pressure differential between respective ends of the tilt device as described above during tilting whereby the lower of the two pressures is normally sufficient to hold the unlock piston 113 in the unlocked position against the springs 115 locking bias during normal tilting. FIGS. 9A and 9B concern the second aspect where the double acting cylinder assembly of the quick hitch is driven via hydraulic relay hoses 116 and 117 which are located within the assembly. FIG. 9A shows fluid flow used to engage the quick hitch and FIG. 9B to release. The hoses 116 and 117 are coiled (see also FIG. 4) to take into account the relative angular movement of the input and output to each hose. The inputs and output are of course reversible depending on fluid flow.

Whilst the above has been given by way of illustrative example of the present invention many variations and modifications thereto will be apparent to those skilled in the art without departing from the broad ambit and scope of the invention as set out in the appended claims.

1. A locking device for a rotatable body coupled to a main body, the locking device having releasable locking means to lock the rotatable body against rotation relative to the main body, the releasable locking means being automatically biassed to a normally locked position and there being release means employed to first release the locking means thereby enabling the rotatable body to be rotated as may be required, the improvement comprising release means adapted to release the locking means while the main body and the rotatable body remain stationary.

2. A locking device according to claim 1 wherein the locking device includes a linear to rotary convertor where first and second drive means drive respective axially moveable pistons to shift the rotatable body to follow a helical guide and thereby tilt.

3. A locking device according to claim 1 wherein the locking device includes a linear to rotary convertor and the release means comprises respective unlocking pistons at opposite ends of the linear to rotary convertor which pistons serve to separate the locking means at each end of the convertor while the convertor remains stationary.

4. A locking device according to claim 1 wherein the locking device includes a linear to rotary convertor and the release means comprises respective unlocking pistons at opposite ends of the linear to rotary convertor which pistons serve to separate the locking means at each end of the convertor while the convertor remains stationary, the release means each comprise an internally tapered end cup, bearing, the said unlocking piston, a locking element and a locking spring, the locking element being adapted to engage the tapered end cup in a locked position under the influence of the locking spring when the piston is in a device locking position.

5. A locking device according to claim 1 further comprising a main piston used for rotation and respective unlocking pistons at each end of the locking device wherein there is control means which comprises a hydraulic control means with respective unlocking pistons and main piston drives pressurised through a common hydraulic drive operable in sequence to firstly unlock the locking means by moving the unlocking pistons at a first hydraulic pressure and then apply a differential pressure to the main piston rotate the rotatable body.

6. A locking device according to claim 1 further comprising a main piston used for rotation and respective unlocking pistons at each end of the locking device wherein there is control means which comprises a hydraulic control means with respective unlocking pistons and main piston drives pressurised through a common hydraulic drive operable in sequence to firstly unlock the locking means by moving the unlocking pistons at a first hydraulic pressure and then apply a differential pressure to the main piston rotate the rotatable body, hydraulic pressure being employed to unlock the device but the device is not under the influence of hydraulic pressure when it reverts to the locked position.

7. A locking device according to claim 1 further comprising release means driven toward each other at opposite ends of the device.

8. A locking device according to claim 1 wherein a scroll is used for rotation and locking is by spring biassed tapered locking elements at opposite ends of the device.

9. A locking device according to claim 1 wherein a scroll is used for rotation and locking is by spring biassed tapered locking elements and a main piston driving the scroll is caused to remain stationary until after the assembly is unlocked.

10. A tiltable tool assembly including a tool in combination with a machine having an articulated arm with the tool assembly mounted at the end of the arm, the tool assembly being mounted on the arm by a hitch assembly, the tool assembly being tiltable and lockable in a selected position by a locking device having opposite ends and employing release means in the form of releasble locking means at each end, and upon unlocking, the assembly remains in the selected position and there being control means including hydraulic drive means to enable tilting of the assembly after it is unlocked.

11. A tiltable tool assembly including a tool in combination with a machine according to claim 10 wherein the control means comprises a hydraulic circuit selectively delivering hydraulic fluid in sequence to the drive means to first unlock and then upon actuation rotate the rotatable body.

12. A tiltable tool assembly including a tool in combination with a machine according to claim 10 wherein a linear to rotary convertor is employed to cause tilting, the convertor being employed in a normally locked position, the control means operating to unlock the convertor then upon actuation rotate the rotatable body to a selected position wherein releasable locking means is deactivated thereby automatically locking the assembly in the selected position.

13. In a tiltable tool carrier having a main body, a rotatable body coupled to the main body and a relay for hydraulic fluid, the rotatable body being able to rotate relative to the main body, and being lockable using a locking device according to claim 1, the relay for hydraulic fluid having an inlet and an outlet connected by an internal flexible hose, the hose being configured for angular displacement of the input relative to the output upon tilting of the tool carrier.

14. In a tiltable tool carrier having a main body, a rotatable body coupled to the main body and a relay for hydraulic fluid, the rotatable body being able to rotate relative to the main body, and being lockable using a locking device according to claim 1, the relay for hydraulic fluid having an inlet and an outlet connected by an internal flexible hose, the hose being configured for angular displacement of the input relative to the output upon tilting of the tool carrier, wherein the hose of the relay at least in part is coiled so that it may coil up or uncoil in response to said angular displacement.

15. A tiltable tool carrier having a main body, a rotatable body coupled to the main body and being able to rotate relative to the main body and a relay for hydraulic fluid having an inlet and an outlet connected by an internal hose, the hose being configured for angular displacement of the input relative to the output upon tilting of the tool carrier.

16. A tiltable tool carrier according to claim 15 wherein the hose is a retractable hose.

17. A tiltable tool carrier according to claim 15 wherein the hose is a retractable flexible hose.

18. A tiltable tool carrier according to claim 15 wherein the hose is a retractable hose made retractable by reason of being configured in at least part as a coil.

19. A tiltable tool carrier according to claim 15 wherein respective said hoses are located at opposite ends of the tool carrier.

20. A tiltable tool carrier according to claim 15 wherein the tool carrier is lockable in a selected position.

21. A tiltable tool carrier according to claim 15 wherein the tool carrier is lockable in a selected position by a releasable spring biassed locking means.

22. A tiltable tool carrier according to claim 15 wherein the tool carrier is lockable in a selected position by releasable spring biassed locking means at opposite ends of the carrier.

23. A tool carrier assembly comprising a main body, a quick hitch and a rotatable locking device between the quick hitch and the main body, the rotatable locking device employing releasable locking means at opposite ends, a scroll plate, a cylinder and piston located inside the cylinder and being located between the respective releasable locking means, the piston being moveable back and forth to tilt the hitch by reason of rotation of the cylinder as a guide travels in the helical guide way of the scroll plate, the hitch being fixed to the cylinder and the main body is fixed to the scroll plate, the releasable locking means at each end comprising internally tapered end cups, respective bearings, an unlocking piston, a locking element and a locking spring.

24. A tool carrier assembly according to claim 23 wherein a relay for hydraulic fluid having an inlet and an outlet connected by an internal hose, the hose being configured for angular displacement of the input relative to the output upon tilting of the tool carrier.

25. A tool carrier assembly according to claim 23 wherein a relay for hydraulic fluid having an inlet and an outlet connected by an internal hose, the hose being configured for angular displacement of the input relative to the output upon tilting of the tool carrier wherein the hose is a retractable hose made retractable by reason of being configured in at least part as a coil.

26. A tool carrier assembly according to claim 23 wherein the assembly is under hydraulic control including an hydraulic circuit delivering hydraulic pressure to the unlocking pistons to unlock the assembly and then automatically delivering hydraulic pressure to subsequently perform the rotation as an apparent seamless manual movement of a manual control.

27. A tool carrier assembly according to claim 23 wherein the assembly is under hydraulic control including an hydraulic circuit delivering hydraulic pressure to the unlocking pistons to unlock the assembly and then automatically delivering hydraulic pressure to subsequently perform the rotation as an apparent seamless manual movement of a manual control and the rotation follows the unlocking by way of an automatic time delay.

28. A tool carrier assembly according to claim 23 wherein the assembly is under hydraulic control including an hydraulic circuit delivering hydraulic pressure to the unlocking pistons to unlock the assembly and then automatically delivering hydraulic pressure to subsequently perform the rotation as an apparent seamless manual movement of a manual control and the rotation follows the unlocking by way of an automatic time delay, the time delay being achieved by a common feed of hydraulic fluid with a bleed valve to delay delivery of pressure to the main piston.

29. A tool carrier assembly according to claim 23 wherein the assembly is under hydraulic control including an hydraulic circuit delivering hydraulic pressure to the unlocking pistons to unlock the assembly and then automatically delivering hydraulic pressure to subsequently perform the rotation as an apparent seamless manual movement of a manual control and the rotation follows the unlocking by way of an automatic time delay, the time delay being achieved by a common feed of hydraulic fluid by using one or more valves actuated at a predetermined pressure following the unlocking to pass pressure to the main piston.
